(19) United States
(12) Patent Application Publication
(10) Pub. No.: US 2002/0069166 A1
(43) Pub. Date: Jun. 6, 2002

(54) Method and system for facilitating buying and selling transactions

(76) Inventors: Lawrence R. Moreau, Manhattan Beach, CA (US); Bryan Richard, El Segundo, CA (US)

Correspondence Address: LYON & LYON LLP, 633 WEST FIFTH STREET, SUITE 4700, LOS ANGELES, CA, 90071, US

(21) Appl. No.: 09/772,530

(22) Filed: Jan. 29, 2001

Related U.S. Application Data
(63) Continuation-in-part of application No. 09/662,564, filed on Sep. 15, 2000.

(51) Int. Cl. G06F 17/60

(52) U.S. Cl. 705/40; 705/26

(57) ABSTRACT

A system and method for facilitating buying and selling of products and services is disclosed. In this system, a merchant who offers products or services to customers may provide its customers an option to pay for the products and services to a collection agent selected by the customer. The collection agent who receives the payments from the customers, in turn, may forward them to the merchant or a facilitator. In one aspect, a merchant offers a product or service to a customer through a communication device or network such as the Internet. The merchant or a facilitator serving the merchant enlists a number of collection agents wherein any one collection agent may receive payment from the customer for the product or service on behalf of the merchant.

### PRIORITY CLAIM

This continuation-in-part application claims priority to co-pending U.S. patent application Ser. No. 09/662,564, filed Sep. 15, 2000, entitled “A Method and System for Facilitating Buying and Selling Transactions,” and co-pending U.S. patent application Ser. No.______ (Attorney Docket No. 258/062), filed Jan. 16, 2001 (Express Mail Label No. EL360933970US), entitled the same. Both of these earlier-filed patent applications are hereby incorporated by reference as if fully set forth herein.

### FIELD OF THE INVENTION

The field of the present invention generally relates to consumer transactions, and more specifically, to transactions for which a credit card is not necessary. The present invention also relates to a system and method for increasing consumer traffic in retail or other locations offering consumer products. The present invention also relates to a system and method for bringing the benefits of internet commerce to various households that might not otherwise enjoy such benefits.

### BACKGROUND OF THE INVENTION

With the advent of computer network technology, an increasing number of consumer transactions are consummated over the Internet. This has created what has been termed “e-commerce” or “electronic-commerce.” In particular, more and more merchants such as retailers, distributors or manufacturers are now offering products and services through the Internet.

For many types of consumer transactions occurring over the Internet, the use of credit cards is currently the most common form of payment method. For example, once a consumer has selected a product or service offered by a merchant operating a web-site, the consumer electronically provides the merchant with a credit card number over the Internet. The merchant verifies the availability of credit with the card's issuer or clearinghouse, and charges the account for the purchase. The card issuer pays the merchant and sends to the consumer a monthly bill that totals all the transactions for that consumer for a particular period. The consumer can pay the issuer by sending a check in the mail or authorizing the issuer to directly withdraw funds from a certain bank account.

Although this use of credit cards is convenient and popular, it suffers from several drawbacks. First, there is always a possibility of credit card fraud. Consumers often fear that an unscrupulous merchant may misuse their credit card information by making other counterfeit purchases using the consumer's credit card account or sell it to others who would make such counterfeit purchases. Exacerbating this fear is the fact that many Internet merchants are often remote or lesser-known entities. As such, many consumers are reluctant to use their credit cards for purchases over the Internet.

Consumers may also be reluctant to use their credit card for online purchases because of the possibility that hackers or computer thieves may be able to access the databases where these transactions are stored and misappropriate the credit card information. Sophisticated computer encryption software programs have been used to address this concern. However, consumers may still have apprehension that such encryption methods are unreliable or not otherwise fail-safe. Furthermore, employing such encryption technology generally increases the overall cost of doing business over the Internet for the merchant and/or the consumer.

Second, privacy concerns may also dampen consumer confidence in e-commerce. By providing their credit card or other information to the merchant, consumers' buying habits and, possibly, their financial information may be compiled, sold and misused. Indeed many consumers believe that the marketing of such information creates serious privacy issues.

Third, not all segments of the consumer population have credit cards. Groups that include minors, teenagers or consumers with poor credit history may not even be able to obtain a credit card because of their age or other limitations. Without an alternative payment option, these segments of the population may be precluded from enjoying the benefits of electronic commerce.

### SUMMARY OF THE INVENTION

The present invention provides a method for facilitating the buying and selling of products and services. In one aspect, a merchant, offering products and/or services, may provide its customers with an option to pay a collection agent selected by the customer for the product and/or services that the customer orders from the merchant. The collection agent may receive the payment from the customer and forward the payment or a confirmation of customer's payment to the merchant or to a facilitator that may be coordinating or monitoring the orders and payments.

In one embodiment of the invention, a merchant offers a product or service to a customer through a communication device or network such as the Internet. The merchant, or a facilitator serving the merchant, enlists a number of collection agents wherein any such collection agent may receive payment from the customer for the product or service on behalf of the merchant. The collection agent forwards the payment or a confirmation of customer's payment to the merchant preferably through the facilitator, and the merchant supplies the product or service to the customer.

In another aspect, the present invention provides a method of increasing customer traffic to a physical commercial establishment. In one embodiment, a consumer may order a particular product or service from a merchant offering the product or service through a communication device or network such as the Internet. The consumer may be referred to visit a collection agent who has an actual physical location to make payments for the product or service. The collection agent may offer the same or additional product or services, related or unrelated, to the product or service ordered by the consumer. By visiting the collection agent to make payment, the consumer may make additional purchase from the collection agent or may have his or her order filled by the collection agent.

In another aspect, information reflecting a consumer's order may be stored in a device having memory. This memory may be accessed by a collection agent when the consumer desires to make payment.

In another aspect, the system architecture and software to effect the system and method of the present invention are provided.

### BRIEF DESCRIPTION OF THE DRAWINGS

FIG. 1 illustrates a system of computers interconnected by the Internet to facilitate buying and selling transactions according to an embodiment of the invention.

FIG. 2 is a schematic illustration of a computer showing certain of its components as used according to an embodiment of the invention.

FIG. 3 illustrates different entities that may participate in the buying and selling transaction according to an embodiment of the invention.

FIG. 4 depicts a flow chart outlining the process for an embodiment of the present invention.

FIG. 5 depicts a flow chart outlining the data exchanges that occur in an embodiment of the present invention.

FIG. 6 depicts an example of using portable memories in conjunction with a system for facilitating buying and selling transactions.

FIG. 7 depicts an example of using personal digital assistants or cellular telephones in conjunction with a system for facilitating buying and selling transactions.

FIG. 8 depicts an example of using a kiosk having a self-payment system in conjunction with a system for facilitating buying and selling transactions.

FIG. 9 depicts an example of an order form according to an embodiment of the invention.

FIG. 10 is a pictorial representation of the communication between the merchant's and the facilitator's computer network systems using IP-Based Socket Connections.

FIG. 11 is a pictorial representation of the communication between the merchant's and the facilitator's computer network systems using HTTP-Based/SOAP Connections.

FIG. 12 is a pictorial representation of the communication between the merchant's and the facilitator's computer network systems using wireless application protocol (WAP) connections.

### DESCRIPTION OF THE PREFERRED EMBODIMENTS

The invention is generally described in the context of Internet-related purchases. However, the invention may also be applied to other purchases conducted remotely such as mail order, catalog, or other types of transactions. Accordingly, the scope of the current invention is not limited to transactions occurring over the Internet or to transactions necessarily involving Internet merchants or other entities conducting e-commerce.

The present invention provides a system and method for facilitating buying and selling transactions. It is contemplated that by using the system, a merchant or other provider of products or services may increase its exposure to a larger group of prospective customers. Likewise, a consumer who may otherwise not be able to conveniently purchase products or services online for lack of a credit card or other reason will benefit from the system. This benefit is achieved by providing convenience to the consumer in that products and services may be ordered online without the need for providing credit card information online. This benefit is also achieved in that the consumer may have a variety of convenient locations at which to pay for or obtain the ordered products or services. The invention will now be described in more detail using the figures and the following description of the different embodiments of the invention.

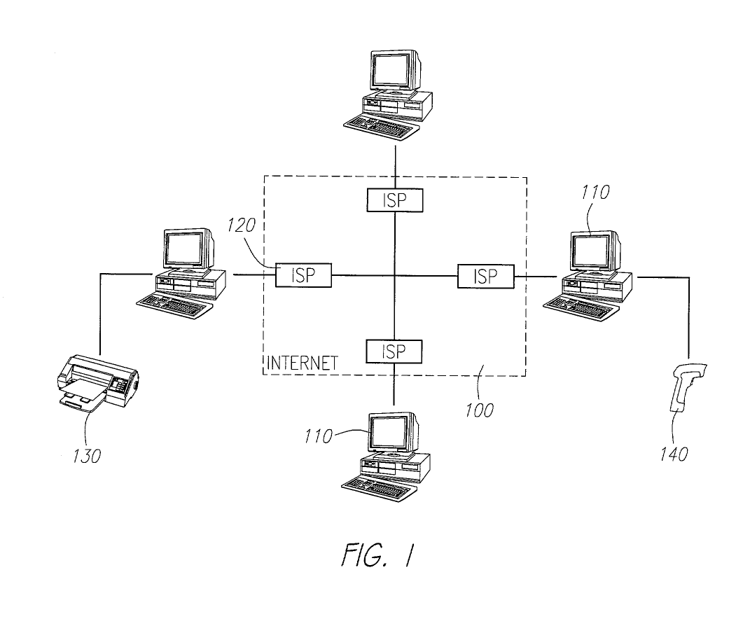

The invention is first described as it may be used with a network such as the Internet. As shown in FIG. 1, the Internet 100 generally comprises a network for facilitating communication between computers 110 or other devices that may interface with the Internet 100 or other network(s). Information may be displayed on computers 110 through a web page or web-site, which is a collection of web pages. The information may initially reside in a particular computer 110 or computer server. Software programs such as web-browsers may then facilitate the transmission of the information to and the display of the information on a second computer or other Web-enabled devices such as personal digital assistants, television, cellular phones, etc. In addition, information such as an order for a product may also be exchanged to and from the different computers 110, servers, or Web-enabled devices.

For the purposes of the following discussion, the term “computers” generally refers to any type of device, including but not limited to the foregoing, through which a consumer or merchant may interact via the Internet 100 or other network. These computers may be interconnected through an Internet Service Provider 120 (ISP) such as America Online, CompuServe, AT&T, Sprint, @Home® or other ISP or other suitable means. The communication between the foregoing elements may utilize communication systems such as integrated services digital network (ISDN), T1 (DS1), T3, DSL, cable lines, wireless systems or other means.

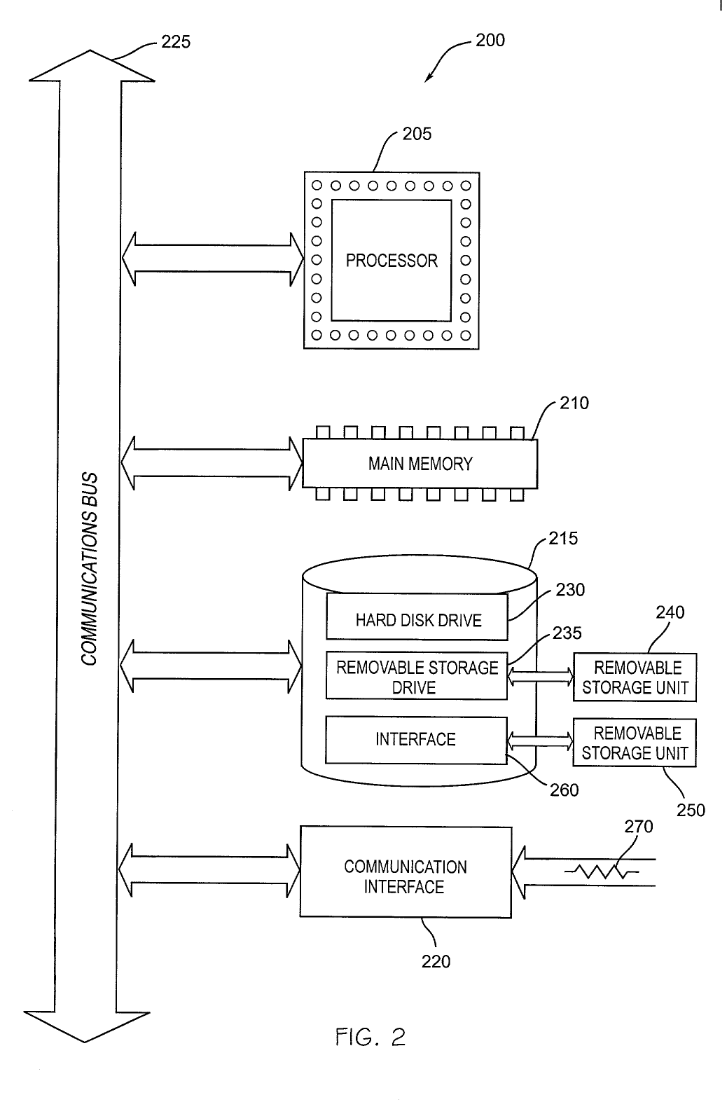

FIG. 2 illustrates various components of a computer system 200 that may be used to implement various aspects of the invention. These computer systems may include one or more processors 205 that may communicate with a main memory 210, preferably random access memory (RAM), and a secondary memory 215, through a communication bus 225. The secondary memory 215, which transfers software and data to the computer 200, may include, for example, a hard disk drive 230, a removable storage drive 235 (such as a floppy disk drive, a magnetic tape drive, an optical disk drive, or flash memory), and removable storage units 240, 250 and interface 260 (such as EPROM or PROM removable memory chips, flash memory cards, PCMCIA cards, or program cartridges and cartridge interfaces similar to those found in video game devices). Alternatively, the secondary memory 215 may include a remote network server accessed via local area network or global network such as the Internet using either direct or wireless connections.

It is also contemplated that the computer system 110 need not include memory. In this situation, computer 110 may communicate with a remote server, for example, and refresh a display screen with information and software stored in the remote server. Indeed, as distributed computing technologies continue to mature, and bandwidth continues to increase, it is contemplated that computers not using memory, or using reduced memory, are more appropriate in the interest of cost and size constraints.

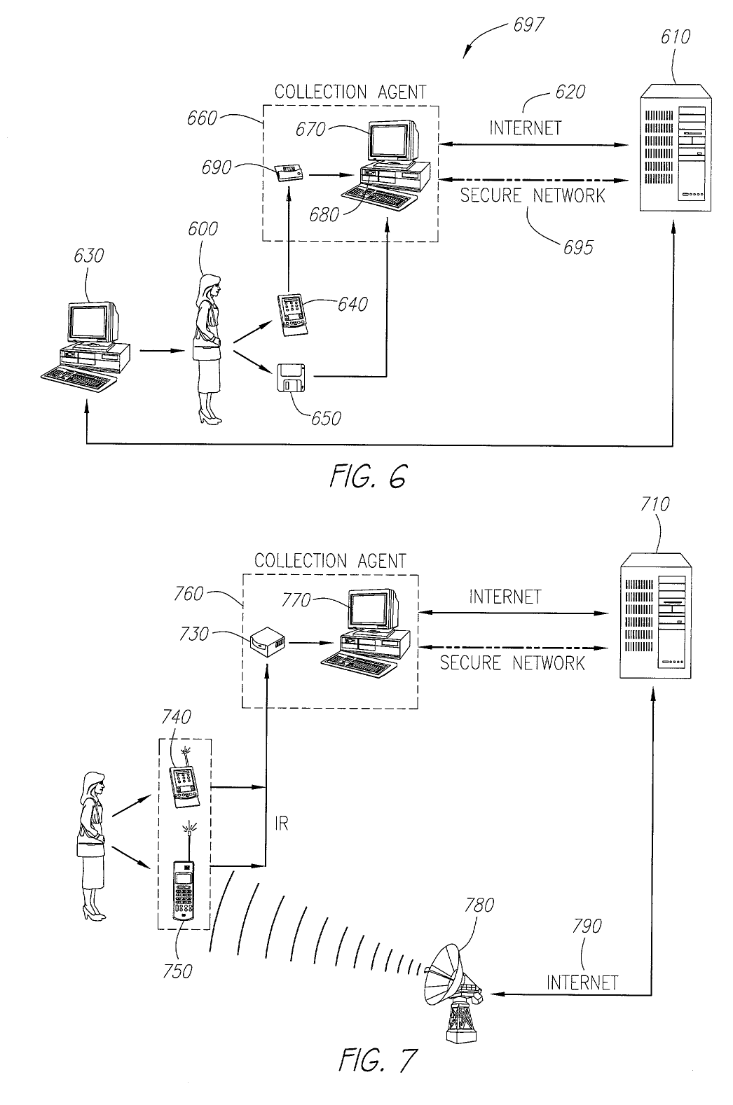

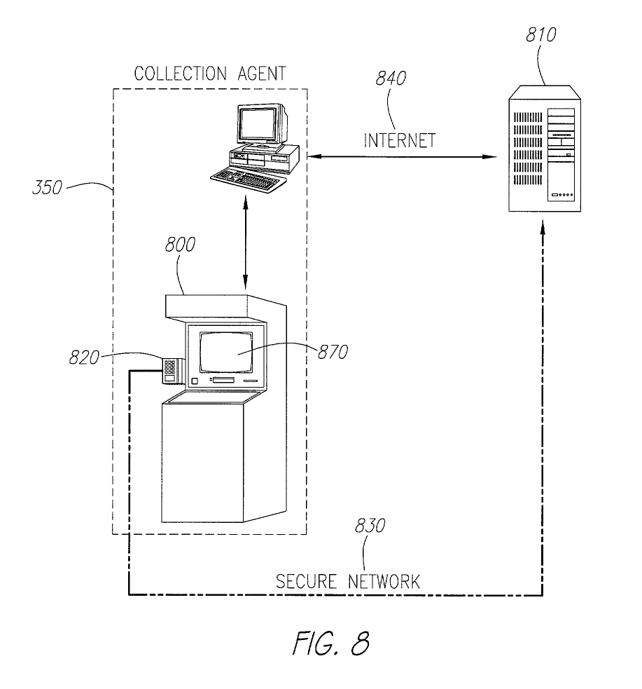

Communications between the computer 110 and external devices (e.g., a printer 130 (FIG. 1), a laser scanner 140 (FIG. 1), a docking station 690 (FIG. 6), a wireless communication port 730 (FIG. 7) for a personal digital assistant, Electronic-Fund-Transfer/magnetic-card reader 820 (FIG. 8), etc.) that may be used by a consumer or collection agent as described below, may be facilitated by communication interface 220 that allows software and data to be transferred between the computer 200 and external devices. Examples of these communication interfaces 220 include direct links such as serial or parallel communication ports, USB or IE1334 ports, modems, network interfaces (e.g., Ethernet cards), PCMCIA slots and cards. Other examples include wireless links such as infrared (IR) ports, analog or digital cellular interfaces. The signals 270 going back and forth between the computer and the external devices may be in the form of electronic, electromagnetic, optical, infrared signals, etc. To enable the computer to perform the functions as described below, computer programs may be stored and executed from the main memory 210 or the secondary memory 215.

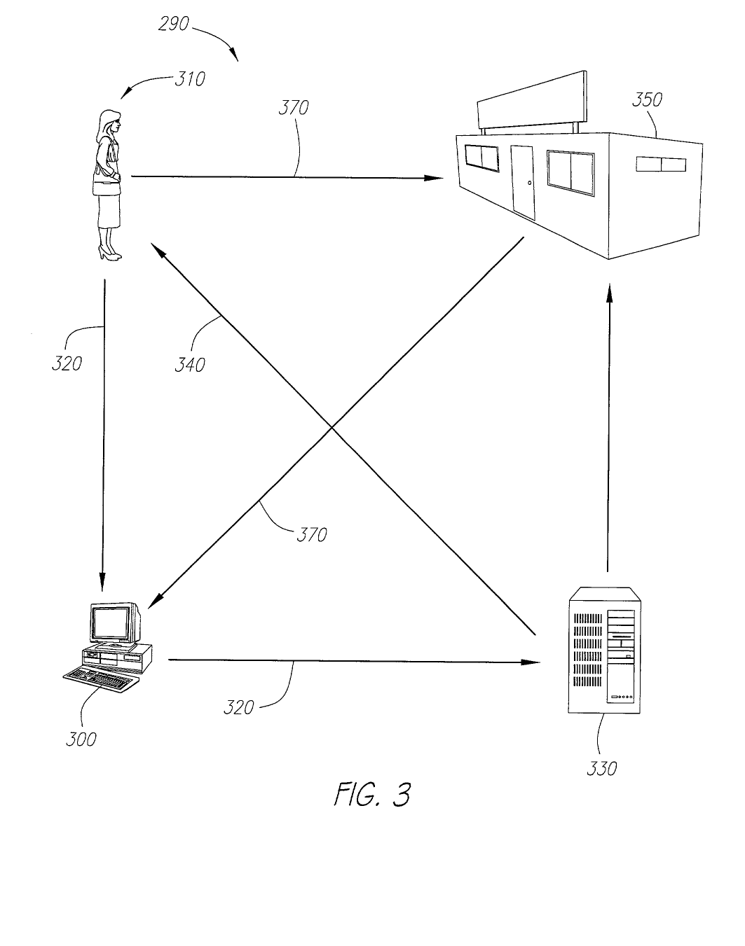

Turning now to FIG. 3, a network 290 for facilitating the buying and selling of products or services is now described. As shown, network 290 may include merchants 300, consumers or customers 310, collection agents 350 and a facilitator 330. Though FIG. 3 shows only one of each of these entities, the present invention contemplates a network whereby a plurality of these entities participate. That is, network 290 may include a variety of merchants 300 preferably offering a wide variety of products or services. It is also preferred that network 290 include a variety of collection agents 350 located in various areas so that consumers 310 may pay for the products or services at a convenient location. While a single facilitator 330 may be used to coordinate and/or monitor orders and payments, the present invention may also involve the use of multiple facilitators.

Merchants 300 are now more fully described. Merchants 300 may include retailers, distributors, manufacturers or any other entity offering goods or services. Merchants 300 may set up an Internet web-site so that products or services are offered online. As shown in FIG. 3, merchant 300 is illustrated as a computer in that merchant 300 may utilize a computer, computer server or other device as described above to advertise or otherwise offer products or services. A customer 310 may also use a computer or other Web-enabled devices to navigate through a merchant's web-site and may select a product or service that he or she may wish to purchase. Examples of these products and services are myriad, which include, but are not limited to, books, computers, computer accessories, food, flowers, facsimile or email services, etc. Indeed, the present invention contemplates the buying and selling of any type of products or services. In this disclosure, “customer” and “consumer” are used interchangeably.

The customer 310 may order a product or service from the merchant 300 by transmitting an order request 320. But instead of providing credit card information over the Internet to the merchant 310, the customer may select a non-credit card payment option. In this manner, the benefits of commerce over the Internet is thus made available to many consumers that do not have, or cannot obtain, credit cards. The order 320 for the product or service may then be transmitted to a facilitator 330. This facilitator 330 may be an independent organization separate from the merchant 300.

Generally, facilitator 330 may serve an overall coordinating function between merchants 300, consumers 310 and collection agents 350. To this end, after receiving the order information 320 from merchant 300, the facilitator 330 may provide the consumer 310 with a list of collection agents 350 (as shown by step 340). Consumer 310 may use this list to choose a collection agent 350 that is convenient to visit to tender payment for the products or services ordered. In some situations, the collection agent 350 may only receive payment, and the ordered goods or services will be provided by the merchant with whom the order was placed. In other situations, consumer 310 may render payment and also obtain the actual products or services from the collection agent 350 that had been ordered from merchant 300. In order to provide this coordinating function, facilitator 330 preferably includes appropriate memory, databases and other hardware and software to accomplish this task. In other words, it is preferred in one embodiment that facilitator 330 has appropriate capability to keep track of which entity actually provided the goods or services ordered by consumer 310.

Generally, collection agents 350 may comprise physical locations, e.g., stores, post offices, banks, or any other convenient locations that have the capability to receive payment, e.g., negotiable instruments such as cash, checks, payment documents or even credit cards. Accordingly, it should be noted that even where a credit card is used at a collection agent, the present invention still provides the benefit of avoiding a consumer's credit card information being transmitted over the Internet. The collection agent 350 may also be embodied as a collection kiosk as will be described further below with reference with FIG. 8. Alternatively, the collection agent 350 may generally be any receptacle for receiving payment.

The collection agent 350 may be local to the consumer, i.e., it may be physically or geographically close to the customer. For example, the collection agent 350 may be a retail store within a mile of a customer's residence, work or school. However, a retail store hundreds of miles away from a customer who lives in a scarcely populated mountain or desert area may also be frequented by the consumer and may thus also embody a collection agent 350 of the current invention.

In any event, the current invention is not limited to situations where the collection agents 350 are within a certain distance from the consumer 310. Indeed, the present invention may accommodate the situation whereby a consumer 310 orders a product or service offered by a store 350 located far away but where the consumers 310 intends to travel. Generally, it is preferred that consumer 310 may be presented with a list of collection agents 350 that suit the consumer's geographic or other criteria.

The collection agents 350 may be unrelated to each other except that they are preferably part of a network 290 of collection agents 350 that will receive payments for products or services ordered from merchants 300. And as mentioned above, the collection agents 350 may be any establishment with a capability to accept payment.

As discussed above, facilitator 330 may serve to coordinate transactions between a plurality of merchants 300 and collection agents 350. In so doing, it is contemplated that facilitator 330 preferably increases the exposure of merchants 300 and collection agents 350 to a larger group of prospective customers. For example, by being included on a list of collection agents 350 at which the ordered product or service may be paid for, a collection agent 350 may experience increased foot traffic in the store. In this manner, collection agent 350 may obtain sales that would not have been made but for the consumer 310 entering the collection agent's 350 establishment to pay for the product or item that was ordered from another merchant 300. In some situations, the collection agent may also gain sales of the ordered product or service itself if it offers that particular product or service.

Conversely, a merchant 300 may more easily obtain orders when a consumer is provided with a list of physical locations at which the ordered product or service may be paid for, or in certain situations, be obtained as well. For example, many consumers are still reluctant to order products online because they would rather interface with a conventional physical store. With this option made available by the present invention, consumers may be more apt to place online orders with merchants 300 because the consumer knows he or she will be able to pay for or otherwise deal with a physical location, i.e., the collection agent.

The relationships between the merchant 300, the collection agent 350 and the facilitator 330 are now further described. The relationships between the merchants 300, collection agents 350 and facilitator 330 may be predetermined by contracts or other agreements. For example, with respect to a merchant 300, the agreement may state that a merchant 300 is to receive the purchase price of a product or service ordered from that merchant 300 less a commission for the collection agent 350 for processing the payment. As another example, where the product or service is ordered from merchant 300, but is paid for and actually obtained at the collection agent 350, merchant 350 may still receive a referral fee. With respect to a collection agent 350, the agreement may provide for the processing fee mentioned above. Or where the collection agent actually supplies the ordered item, the agreement can provide that the collection agent receives the purchase price less a referral fee for the merchant 300. The agreement(s) may also provide for fees to be paid to facilitator 350 for coordinating the system.

The pertinent agreement(s) may be maintained at the facilitator's web-site through which the benefits and general operation of the system and method of the network 290 may be displayed. If a merchant 300 or collection agent 350 desires to participate, it may do so by agreeing to the terms and conditions of an online agreement set forth by the facilitator 330. Alternatively, conventional hard-copy agreements may be used.

It is preferred that the facilitator 330 enlists a number of merchants 300 and collection agents 350 in network 290. This preferably creates flexibility which in turn leads to increased commerce. For example, providing a consumer 310 with a wide array of collection agents located in various areas preferably leads to increased purchases because the consumer 310 will be provided with a wide array of locations at which to pay for ordered products and services. Furthermore, providing a consumer with a wide variety of merchants 300 preferably increases commerce since the consumer 310 will be apt to use network 290 because it represents a wide variety of shopping opportunities.

The collection agents 350 and the merchants 300 may be independent and separate entities, but may also, in some situations, be related such as in a wholesaler-retailer or manufacturer-retailer relationship. It should also be noted that a particular merchant 300 may also be the same or affiliated entity as a particular collection agent 350. That is, a merchant 300 may simply be the e-commerce portion, or Internet presence, of a particular collection agency. Examples include Target®, Toys “R” Us®, or Barnes and Noble Bookstore, which offer products over the Internet in addition to their regular physical stores.

It is also envisioned that, in some situations, a facilitator 330 and a particular merchant 300 or collection agent 350 may be the same or affiliated entity. In this situation, the particular merchant 300 or collection agent 350 may perform the function of the facilitator 330, and an independent and separate entity acting as a facilitator 330 may not be required. The particular merchant 300 or collection agent 350 acting as the facilitator 330 may then enlists a plurality of collection agents 350 or merchants 300 to participate in the network 290, in addition to serving as a merchant or collection agent in the network 290.

As collection agents 350 agree or otherwise elect to participate in the network 290, the collection agent 350 is preferably issued a unique agent identification number or code (Agent or Location ID). These identification codes may be assigned by facilitator 330. The facilitator 330 may also compile the information regarding the collection agents such as names, addresses, phone and fax numbers and/or other information into an electronic database. The database may also include e-mail addresses, withdrawal account routing information that the collection agent has pre-authorized the facilitator to withdraw from for the purposes discussed below. The database may also include deposit account information. It may also include the status information of the collection agent 350, i.e., whether the collection agent 350 is an active/inactive or a valid/revoked member of the network 290. In general, the database may contain any other information regarding collection agents 350 for use in facilitating transactions over network 290 or other purposes, e.g., marketing information of the participants in network 290.

As merchants 300 agree or otherwise elect to participate in the network 290, the facilitator 330 preferably issues a unique merchant identification number or code (Merchant ID) to each participating merchant. The facilitator 330 may also compile a second electronic database (or further adds to the database with collection agent 350 information) with the information regarding these participating merchants 300. Such information may include the merchant's name address, phone number, URL address, email, and preferably, a deposit or withdrawal account routing number for purposes discussed below. The database may also include classification as to the type of merchant, the type of online shopping cart that the merchant uses, and the status of the merchant, i.e. whether the merchant is an active/inactive or a valid/revoked member of the network 290. In general, the database may contain any other information regarding merchants 300 for use in facilitating transactions over network 290 or other purposes, e.g., marketing information of the participants in network 290.

The facilitator 330 may charge the merchants or collection agents a fee for the right to participate in the network 290. Such fee may be a flat monthly fee, a percentage of sales for a particular transaction, or other types of arrangement. However, it is believed that such a fee would be justified in light of the increased exposure to possible sales for both merchants 300 or collection agents 350. Such a fee might be obtained through use of the withdrawal account information of each merchant 300 and collection agent 350.

It is preferred that any merchant 300 participating in the network 290 be able to provide its customers with the option to pay by a non-credit card method or to pay offline. Upon electing the non-credit card option or offline payment method, the customer 310 may then be presented with a list of collection agents 350 and their locations where the customer can visit and pay for the product or services ordered from the merchant 300. It is preferred that a list of collection agents be presented to the consumer 300 according to any desired criteria set forth by the consumer. To facilitate non-credit card transactions, the merchants' home page would preferably advertise non-credit card or offline payment option.

A sample transaction occurring over network 290 is now discussed in more detail. In one type of transaction of the present invention, it is contemplated that a consumer 310 may order a product or service from a participating merchant 300, and then visit a participating collection agent 350 to make payment for the ordered product or service. In this manner, consumers that do not have credit cards may still use the Internet in an e-commerce fashion. That is, a consumer 310 may browse the web-sites of various merchants 300 from the comfort of his or her own home (or other location) to determine what products and services are available from which merchants and at which locations.

The consumer 310 may order a product or service from the merchant by sending an email to the merchant or, if the merchant's web-site is so equipped, the consumer may select the product or service and add it to an electronic shopping cart. An electronic shopping cart is a figurative description of an electronic order file whereby the file includes the quantity, catalog number, description of the product or service, or price of the product or service. The consumer may order items from a merchant through other appropriate means, e.g., through the mail or by fax.

After a product or service is ordered, the consumer—even if he or she does not have a credit card—may then be presented with a list of collection agents 350 at which the product or service may be paid for with cash or other types of payment including credit cards. Upon payment 370 by the consumer 310 to the collection agent 350, the collection agent 350 may forward the payment 370 or a confirmation of payment to the corresponding Internet merchant 300 at which the order was generated. As discussed below, the forwarding of the payment 370 may occur via, or with the assistance of, the facilitator 330. As such, and with reference to FIG. 3, payment (or confirmation thereof) 370 may proceed from collection agent 350 through facilitator 330.

The forwarding of payment may occur electronically through the use of the electronic accounts as mentioned above. In non-electronic embodiments of the current invention, payment may be routed through other means such as the mail. The guidelines for forwarding payment may be set forth in the agreements entered into by the collection agent 350 and merchant 300 upon their decision to participate in the network 290.

An example of forwarding the payment electronically may include transactions involving the Automatic Clearing House (ACH) whereby the collection agent 350 transmits or gives authorization to the facilitator 330 to withdraw the amount of payment from the collection agent's withdrawal account. The facilitator 330 may in turn directly deposit the amount of payment to the deposit account of the merchant 300 from which the product or service was ordered. Alternatively, the facilitator 330 may also provide the collection agent 350 with the direct deposit account of the corresponding merchant 300 and the collection agent 350 authorizes its bank to transfer the amount of payment to the merchant's direct deposit account. And as discussed above, the amount of payment from the collection agent 350 to the merchant 300 may reflect a processing fee retained by the collection fee or a processing fee for the facilitator 330.

After the collection agent 350 has forwarded the payment (or confirmation thereof) or the corresponding merchant 300 has been otherwise notified that payment has been received, the merchant 300 may ship the product directly to the consumer's location such as his or her home, place of work, or any other place that the consumer may designate.

In this situation, the collection agent 350 need not offer the actual product or service offered but instead may simply serve as a convenient location for the consumer to pay for the order. Examples of convenient locations may include post offices, banks, notary public, stores or any other location that may receive payment. The collection agent 350 may also offer other products or services than that ordered. And when consumers 310 visit the collection agent 350 to pay for the ordered item, this preferably increases customer traffic to the store and may result in additional purchases from the store even though these purchases are unrelated to the original order.

For example, a consumer may order a skateboard, a baseball bat or other item from a particular Internet merchant 300 offering sporting products. The consumer 310 may then select and visit a supermarket that participates in network 290 and that is close to consumer 310 to pay for the sporting good. In visiting the supermarket, the consumer 310 may be reminded that he or she needs to buy some food or beverage items. This increased traffic may translate into increase sales and may motivate the store to perform the collecting service 370 for the merchant 300. The agreement between collection agent 350 and facilitator 330 may provide for commissions on the unrelated sales resulting from increased foot traffic.

The collection agent 350 may receive a fee from the Internet merchant 300 for its services as a payment center. The collection agent 350 may deduct a part of the payment being transmitted to the merchant 300. The amount deducted may be equal to the fee that the merchant 300 has agreed to when initially participating in the network 290. This may be the arrangement in situations where the local store does not have the product the consumer ordered from the merchant. This fee may be a flat transaction fee or expressed as a percentage of the sale.

In another type of transaction of the present invention, the consumer may order the product or service from an merchant 300, then tender payment and also pick up the product at a collection agent's location. In this type of transaction, the collection agent 350 may fill the order from its own stock or may have the merchant 300 ship the product to the collection agent 350. For example, the consumer 310 may again order a sporting good from a particular merchant 300 offering sporting products. The consumer 310 may then select to visit a different but local sporting goods store that may actually carry the sporting item ordered. In this situation, the local sporting goods store may fill the order and provide the consumer 310 with the sporting good. The local sporting goods store may then forward only a part of the payment to the merchant 300 since the actual product or service came from that collection agent's 350 inventory. However, the partial payment may still be forwarded to the originating merchant 300 as a referral fee.

The amount of referral fee and other associated terms and conditions may be as agreed previously by the merchants 300 and collection agents 350 when deciding to participate in the network 290. Alternatively, if the local sporting goods store 350 does not carry the sporting good and the consumer wishes to remain anonymous to the Internet merchant 300, the merchant 300 may ship the sporting good to the local store for the consumer 310 to pick up. But even in this situation, consumer traffic to the local store is increased which may lead to consumers making additional purchases beyond the products or services ordered.

In another type of transaction of the present invention, a kiosk 800 may be placed in or near the collection agent 350 or at some other location as shown in FIG. 8. The kiosk 800 may include a computer or other Web-enabled devices that provide a connection to the network 290. The kiosk 800 may also include a printer for printing an invoice 900 such as that shown in FIG. 9. Such invoices will be described more fully below. The kiosk 800 thereby allows consumers to participate in e-commerce despite the fact that they may not own a computer or other device to access the Internet.

A consumer 310, visiting the collection agent 350 may use the kiosk 800 to access the Internet and the network 290 to order products or services from a merchant 300. Payment for the products or services, which were ordered from the Internet merchant 300, may then be made to the collection agent 350 along with payment for any other products or services provided by the collection agent 350 that the consumer 310 may have purchased. This arrangement adds value to the collection agent's business in that it may provide a one-stop shopping convenience for the consumer 310, i.e., besides offering its own products or services, the collection agent 350 allows the consumer to order other items that the collection agent 350 may not carry.

For example, a consumer 310 may visit a collection agent 350 such as a supermarket or grocery store to do his or her regular grocery shopping. While at the store, the consumer 310 may remember that he or she needs or desires a particular product that may not be offered by the store. However, the consumer may have limited time to spend on shopping. Thus, he or she may go to the kiosk 800 at the collection agent's location, order the product from merchant 300, and pay for the ordered product and all of his or her groceries together at the collection agent 350. This may effectively transform a regular store into a superstore with access to an unlimited variety of products and services and that provides a consumer 310 with all of his or her buying needs in one location. Upon payment to the collection agent, an authorization may be transmitted from the collection agent 350 to the merchant 300 which results in the product being shipped to the consumer 310. And as discussed above, the collection agent 350 may forward payment to the merchant 300 less some amount for a transaction fee. Also, the payment may be routed from collection agent 350, through facilitator and to merchant 300.

In another type of transaction of the present invention, it is contemplated that a consumer 310 may order or select a product or service from merchant 300 online through the Internet. The collection agent 350 may be a related entity to the merchant 300, e.g., the merchant may simply be the e-commerce portion, or Internet presence, of a particular collection agenct. However, this type of merchant/collection agent relationship is not necessary. Through the order over the Internet, the consumer may receive a coupon from the merchant 300 that can be printed on the consumer's printer, a kiosk printer at or near a collection agent, or other printer.

The coupon may provide promotional discounts for either the product or service ordered or other products or services. The consumer may redeem the coupon by presenting it to the collection agent 350 and receiving the discount for the product or service specified in the coupon. The consumer 310 may then pay to the collection agent 350 the discounted price for the product or service ordered as specified in the coupon. The collection agent 350 may supply the product or service to the consumer if the collection agent has the particular product or service in stock. If the coupon specifies a product or service other than the one ordered, the collection agent 350 may also supply the product or service specified in the coupon at the discounted price. Coupons may be used for various other types of promotions with the current invention as well. As such, the current invention provides an avenue for effective marketing through coupons.

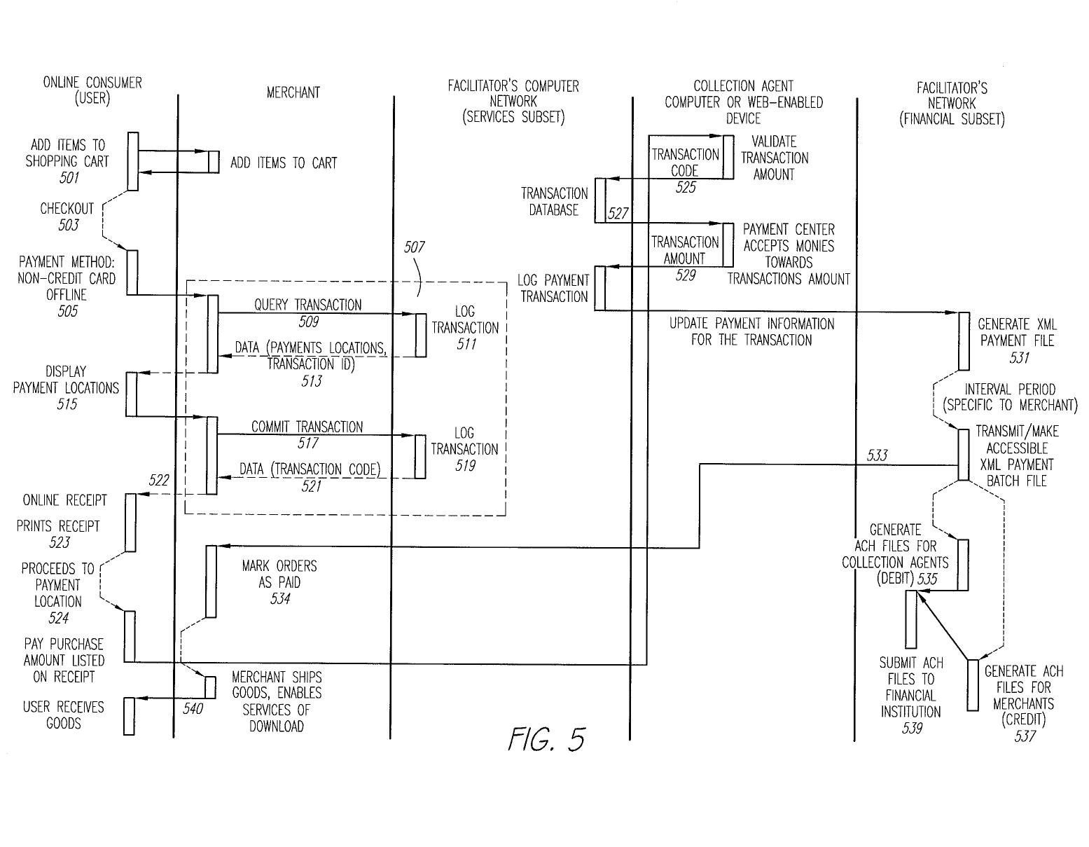

In yet another type of transaction of the present invention, the consumer 310 may order a product or service from a merchant 300 who offers products or services through a catalog or other non-Internet medium. The consumer 310 may call or otherwise contact the merchant 300 using a telephone, mail, fax or other means to place an order. The merchant 300 may then provide the consumer 310 with a list of collection agents 350. This list may be provided over the telephone, mail, fax, etc., to the consumer 310. In addition, the merchant may provide a transaction code over the telephone, mail or fax an invoice with the transaction code as shown in FIG. 5. FIG. 5 is discussed in more detail below.

Thereafter, the consumer 310 may present the invoice or the transaction code to a collection agent 350 of the consumer's choice. The consumer 310 may then provide payment to the collection agent 350. The collection agent 350 may then forward the payment as discussed above in connection with the different types of transactions of the present invention. After receiving the payment or a notification of payment from the collection agent 350, the merchant may then ship the product to the consumer 310 or to any other location the consumer 310 may designate.

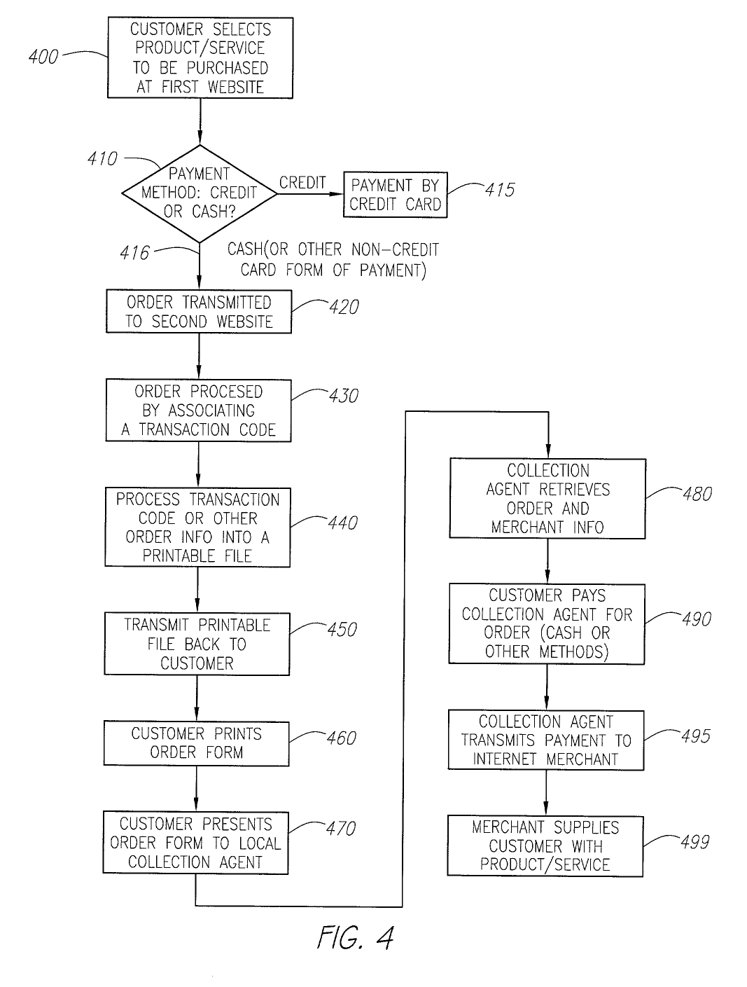

The process by which information is transmitted over network 290 is now discussed more fully with reference to FIG. 4. In step 400, the customer may select a product or service to be purchased from a merchant, e.g., at a first web-site operated by an Internet merchant. The merchant may provide the customer with a choice at checkout as to payment by credit card or cash (step 410). If the customer selects to pay by credit card, step 415 may then occur in accordance with currently available credit card payment methods.

If the customer selects to pay by cash (or with some other non-credit card form of payment, i.e., to pay “offline” with a collection agent 350 affiliated with the network 290) as in step 416, the order information may be transmitted as in step 420 to a facilitator 330, e.g., to a second web-site operated by the facilitator 330. The facilitator's web-site may reside on a different computer server than the merchant's computer server. However, the same computer or server could also be used. To this end, the facilitator may provide the service of constructing web-sites for participating merchants 300. In this situation, the merchant's web-site may very well reside on the same server as the facilitator's web-site. Also in this situation the agreement between the merchant 300 and facilitator 330 may provide for the fees and other terms that pertain to web-site construction.

An example of how the consumer may select to make payment by cash may involve clicking a button or hypertext link on the merchant's web page. This click may trigger a servlet, an applet, a script, a firmware, or any other appropriate software that will encapsulate the order information such as quantity, catalog number, description, price, etc., into an electronic file, preferably an Extensible Mark-Up Language (XML) document. Alternatively, the information encapsulated in the XML file may include only information such as a merchant ID issued by the facilitator 330, an order ID issued by the merchant 300, a customer ID issued by the merchant 300, a transaction amount or the amount of payment, a currency-type designation and a postal code and country selected by the customer 310. In this situation, the facilitator 330 need not have access to the details of the transactions or to the customer's personal information.

The electronic document may then be transmitted to the facilitator 330, e.g., the server for the operator of the second web-site. The merchant information, which is preferably already stored in a database maintained by the facilitator, may be retrieved by using a unique identifier such as the Uniform Resource Locator (“URL”) of the merchant's web-site where the transmission originated or a merchant ID issued by the facilitator 330.

In step 430, the facilitator may then process the order that was transmitted. For example, the facilitator may receive the XML document transmitted above and parse the encapsulated order information. That is, a parsing routine may be used which evaluates the XML document and places the data thereof in the appropriate record(s) in a relational database such as an Oracle database. The particular order may also be associated with a corresponding transaction code or identifier for the purposes discussed below. The transaction code or identifier may be any type of alphanumeric designation. Preferably, the transaction code is also presented in a bar code format that may be scanned by a laser scanner 140 (FIG. 1), similar to that used in current retail or grocery stores.

In step 440, the transaction code along with the order information may be processed into a printable file or a XML document and transmitted back in step 450 to the customer's computer or terminal. Alternatively, the printable file or XML document may also be sent to the merchant's web-site and displayed to the consumer. This printable file may be printed out in step 460 as an order form or invoice 900 (FIG. 9) with the consumer's printer, the kiosk's printer or other printer, or saved in the consumer's computer.

In the situation where a consumer is already at a collection agency 350 when accessing the network 290, e.g, the consumer is using a kiosk 800 (FIG. 8) located at the collection agency 350, it is contemplated, though not necessary, that the consumer will tender payment at that same collection agency. But regardless from where the product or service is ordered, the second web-site, e.g., facilitator 330, may also present the consumer with a list of collection agents that participate in network 290. This list of collection agents may be generated according to criteria specified by the customer.

For example, the customer may want a list of collection agents within a certain distance or travel time. To this end, the consumer may have to provide a street name, a city, a zip code, a complete address, or a phone number indicating where he or she is located or where he or she wants to pay for the ordered item. A proximity algorithm may then take part or all of the information and calculate a certain number of participating collection agents that are geographically close or desirable to the consumer. Alternatively, the consumer may ask for all the collection agents in a particular city or inquire whether a particular local establishment is a participating collection agent. The customer may print or save the list of collection agents and their address and phone numbers.

After the customer prints the order form in step 460, he or she may then present it to a collection agent 350 of his or her choice as in step 470. Preferably, the collection agent is equipped with a laser scanner that can scan the bar code associated with the order information. If not, the collection agent 350 may simply enter the alphanumeric transaction code into its computer system or a wireless access protocol (WAP) enabled device using common user-interfaces such as keyboard or touch-screen LCD displays. Examples of WAP-enabled devices include personal digital assistants with wireless Internet access, cellular telephones and pagers. The computer system or the WAP enabled device of the collection agent preferably communicates with the computer server of the facilitator through the Internet or other communication networks.

Using this communication network, the collection agent's computer in step 480 retrieves the order information, preferably in the form of an XML document, along with the Internet merchant identification from an electronic database maintained by the facilitator 330. This database includes, but is not limited to, the order information as to price, quantity, and description of product. Preferably, this database also includes a deposit account and its routing number that the corresponding merchant of the order has previously set up.

Another example of this communication may involve accessing the facilitator's computer server using regular web browsers. Web applications may reside in the facilitator's server for retrieving the transaction and the amount of the payment to be received. The Web applications may also allow the collection agent 350 to mark the transaction as paid when the payment has been received from the customer 310.

As described above, in situations where the collection agent 350 does not have the particular product or service ordered, the customer may pay the collection agent in step 490 with any form of negotiable instrument such as cash or check. Payment may also be made using a credit card since the customer 310 will avoid having his or her credit card information transmitted over the Internet, and/or the customer may be familiar with the collection agent 350 and trust the collection agent 350.

Upon receipt of the payment, the collection agent 350 forwards the payment (step 495) to the merchant 300 or vendor through a variety of ways, but preferably electronically by pre-arranged deposit accounts. For example, the amount of payment may be directly withdrawn from the bank account of the collection agent 350 who has already pre-authorized the withdrawal by the facilitator 330 and is directly deposited into the merchant's 300 deposit account using already available ACH system used by banks. Step 495 may alternatively involve the transmission of a payment authorization or confirmation which notifies merchant 300 that payment has been received by collection agent 350.

When the merchant 300 receives payment for the product or service, it may then ship the ordered product or service to the customer 310 as in step 499. Alternatively, the merchant 300 may ship the product upon the collection agent 350 sending an “authorization to ship” or a confirmation of payment message to the merchant 300 notifying it that payment has been received for the particular order.

If the customer 310 is concerned with privacy, he or she need not provide personal information for the transaction to the merchant 300. Instead, the collection agent 350 may act as a receiver of the product wherein the Internet merchant ships the product to the collection agent 350, and the customer 310 picks it up from the collection agent 350. Furthermore, if the collection agent 350 has the particular product or service ordered by the customer, the collection agent 350 may fill the particular order by providing the ordered product or service to the customer 310. The collection agent 350 may inform the facilitator 330 through the communication network connection and forward only a part of the payment as a referral fee to the referring merchant, i.e., the original merchant which first offered the product or service and with which the order was placed. The collection agent 350 may use the same merchant deposit account information to forward the payment.

A preferred method of exchanging information relating to the purchase and payment transactions over the network 290 will now be described with reference to FIG. 5. After the customer 310 adds an item or items to the merchant's 300 electronic shopping cart (step 501) and proceeds to checkout (step 503), the customer 310 may select to pay by non-credit card or offline method (step 505). The selection to pay by a non-credit card or offline method triggers a series of data exchanges between the merchant's server and the facilitator's server. These data exchanges are generally depicted in the box numbered 507 in FIG. 5. It should be noted that the general exchange of information between merchant 300 and facilitator may occur where both reside on one server.

The data exchanges include a QUERY Transaction (step 509) that is sent from the merchant's server to the facilitator's server. The purpose of the QUERY Transaction is to establish an order with the facilitator 330 and to return a list of potential collection agents 350 and their locations to the customer 310. For example, data in the QUERY Transactions may include the following:

| Name | Description |
|---|---|
| Transaction Type | In this instance: 1000 = QUERY |
| Merchant ID | Facilitator-issued identification number or |
| | code |
| Order ID | Merchant-issued unique identifier for the |
| | particular order |
| Customer ID | Merchant-issued unique identifier for the |
| | customer who placed the order |
| Postal Code | To be used for returning a relevant or |
| | proximally located collection agent |
| Country | To be used for returning a relevant or |
| | proximally located collection agent |
| Transaction Amount | Total amount of purchase for the particular |
| | order |
| Currency Type | e.g., United States = U.S. Dollars |
| Distribution ID | facilitator's internal code indicating what |
| | type of software distributed by the |
| | facilitator is connecting |
| Version | facilitator's version of distribution |

Once the facilitator 330 received the QUERY Transaction, the facilitator 330 may log the transaction (step 511) into a database and return a first set of data to the merchant (step 513). The first set of data to be returned may include, for example:

| Name | Description |
|---|---|
| Transaction Status | PASS/FAIL Code |
| Transaction ID | Globally unique identifier for this particular |
| | QUERY Transaction |
| Collection Agent Data | May include unique Location ID(s), |
| | Collection Agent(s)' names, addresses, and |
| | phone numbers |

Once the merchant 300 receives the first set of returned data, it may, in turn, display the collection agent information and location to the customer (step 515). This allows the customer to decide if he or she wishes to pay at any of the collection agents 350 displayed or listed and, optionally, if he or she wishes to ship to any of the listed collection agents 350. It is contemplated that the QUERY Transaction (509) is not absolutely necessary, but is preferred as a service to the customer 310. Thus, it is contemplated that the QUERY Transaction may be bypassed or removed without hindering the whole transaction.

Once a customer 310 decides to commit to paying a collection agent 350 listed or displayed, the customer may simply click on a COMMIT button on the merchant's web-site, which would trigger a COMMIT Transaction (step 517) to be sent to the facilitator's server from the merchant's server. The purpose of the COMMIT Transaction is to flag a QUERY Transaction in the facilitator's server as eligible to accept payment offline at a participating collection agent 350. The data in the COMMIT Transaction may, for example, include:

| Name | Description |
|---|---|
| Transaction Type | In this instance: 2000 = COMMIT |
| Merchant ID | facilitator-issued identification number or |
| | code |
| Transaction ID | Globally unique identifier for the particular |
| | QUERY Transaction being committed to |
| Transaction Amount | Total amount of the purchase for the |
| | particular order. |

Upon receipt, the facilitator may log the transaction (step 519) and return a second set of data to the merchant's server (step 521). The second set of data may include, for example:

| Name | Description |
|---|---|
| Transaction Status | PASS/FAIL Code |
| Transaction Code or | Facilitator-issued code for the purpose of |
| Authentication ID | uniquely identifying a payment |

The Transaction Code or Authentication ID is the same transaction code or identifier described in steps 430 and 440 in FIG. 4, with which the order is associated and based on which the Transaction Amount may be made known to the collection agent 350 so that the collection agent 350 knows how much payment should be received from customer 310.

The data that is exchanged between the merchant 300 and the facilitator's 330 server may be formatted in any number of ways. For example, the data may be sent in the form of a Delimited Value Files (DVF) string such as Comma Delimited Value. Alternatively, the data may be sent in an Extensible Markup Language (XML), or any other format. It is preferred that the format used conforms to the data rules for their respective types, e.g. data order for DVF and facilitator's transaction schemes for XML.

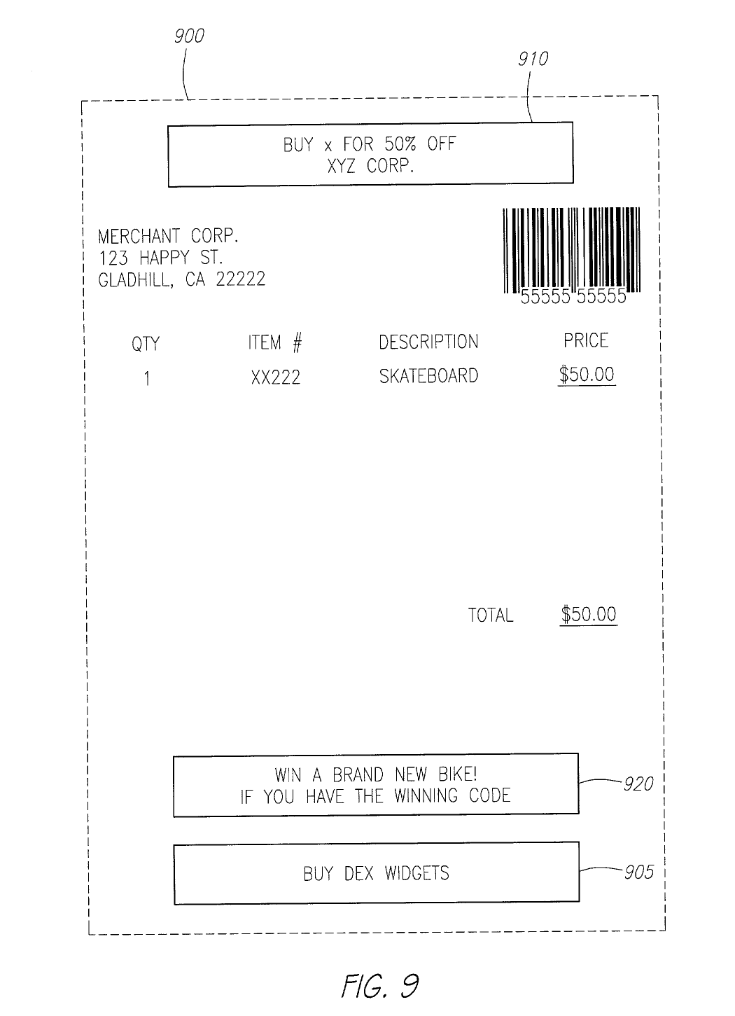

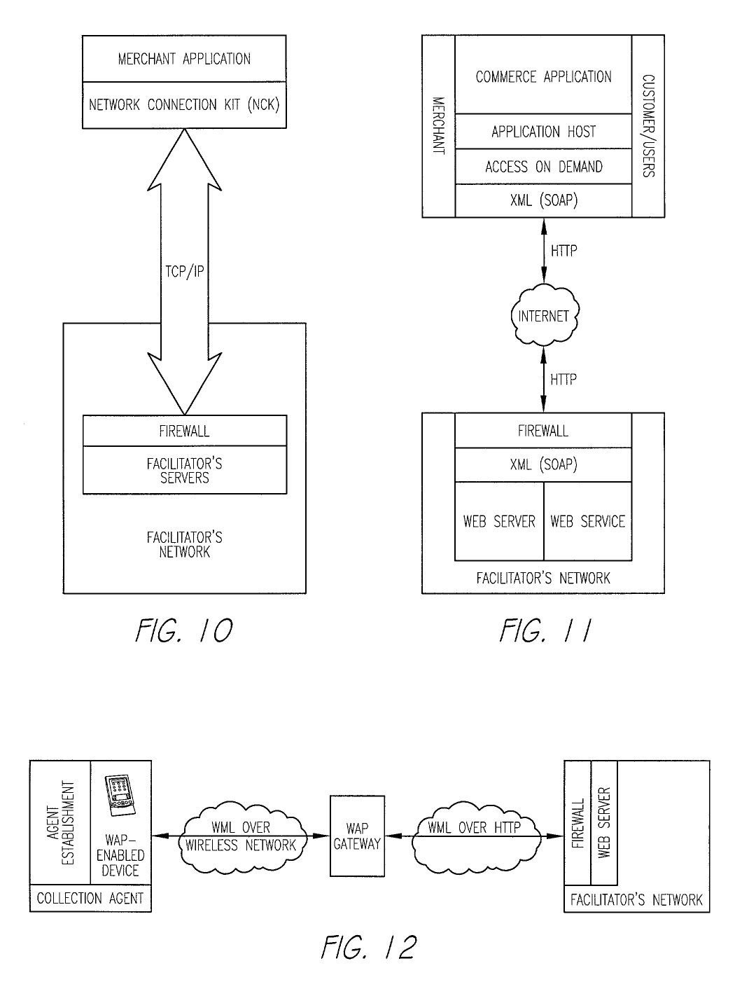

The exchange of data between the merchant 300 and the facilitator's 330 server may also occur using different types of connections. For example, the exchange may be made through Internet Protocol (IP) Based Socket Connections using standard Windows or UNIX sockets. When using sockets (IP address of a station plus a port number) which direct data to an appropriate application in a TCP/IP network, the facilitator's 330 server(s) on the TCP/IP network “listens” on a specific port for incoming connections from a merchant 300 running the facilitator's 330 Network Connection Kit. (See FIG. 10) The combination of the Network Connection Kit and the facilitator's 330 computer network may form a two-way connection allowing the merchant's Web application to both send data to the facilitator's 330 computer network as well as to receive the data and response in real time. To increase security, the data may also be encrypted on either the merchant's 300 or the facilitator's 330 end prior to the transmission. This is advantageous in that encryption reduces the overhead associated with secure sockets.

The Network Connection Kit may include software codes, which may be integrated by the merchant 300 to its Web applications to facilitate the exchange of data with the facilitator's 330 server. The software codes may be in the form of a script (e.g. PERL or ASP scripts), applet, servlet, firmware or any other appropriate software that will facilitate the exchange of data between the merchant 300 and the facilitator's 330 server. An example of the software codes for the Network Connection Kit in PERL script is provided herein at the end of the written description before the claims. The example lists two PERL scripts: one for the QUERY Transaction (File: queryTransaction.pl) and another for the COMMIT Transaction (File: commitTransaction.pl).

In addition to the Network Connection Kit, the facilitator may also provide the merchant 300 with necessary IP addresses, ports, authentication data, and encryption keys for connection and usage of the facilitator's 330 computer network.

Alternatively, data may also be exchanged through remote automation or Remote Procedure Call (RPC), which is a programming interface that allows one program to use the services of another program in a remote machine. The calling programming sends a message and data to the remote program, which is executed, and results are passed back to the calling program. For example, remote automation may utilize an HTTP-Based Transaction that uses Simple Open Access Protocol (SOAP) or XML-type RPC. (See FIG. 11)

SOAP is a lightweight protocol suitable for exchange of information in a decentralized, distributed environment. It is an XML based protocol that consists of three parts: an envelope that defines a framework for describing what is in a message and how to process it, a set of encoding rules for expressing instances of application-defined datatypes, and a convention for representing remote procedure calls and responses. (See FIG. 11). This model will allow customers 310 to either call procedures remotely on the facilitator's 330 computer network and thereby access its services or to transmit XML data or file over HTTP.

When communicating with the facilitator's 330 computer network, the merchant's 300 Web applications may use what is known as SOAP messages. A SOAP message is an XML document that consists of a mandatory SOAP envelope, an optional SOAP header, and a mandatory SOAP body. The SOAP envelope is the top element of the XML document representing the message. The SOAP header may be a generic mechanism for adding features to the SOAP message in a decentralized manner and without prior agreement between the communicating parties. SOAP may also define a few attributes that may be used to indicate who should deal with a feature and whether it is optional or mandatory. The SOAP body may contain mandatory information intended for the ultimate recipient of the message. SOAP may also define one element for the body as a fault element for use to report errors. The data in the SOAP messages may also be encrypted prior to transmission or may be used with HTTPS to increase security.

Referring again to FIG. 5, after the facilitator 330 returns the second set of data in step 521, the merchant 300 may, in turn, display the Transaction Code or Authentication ID to the customer 310 (step 522). The customer 310 may either print an online receipt (step 523) similar to that described in step 460 of FIG. 4, copy the Transaction code, or save the Transaction Code into a memory as will be described fully below with reference with FIGS. 6-8.

Using the above described methods, data may be exchanged between the merchant's 300 server and the facilitator's 330 server without the need for the customer 310 to proceed through cumbersome registration steps in order to elect to pay by non-credit card or offline method. The customer 310 also does not have to leave the merchant's 300 web-site, which increases the overall convenience for the customer 310. As a result, the customer 310 may be more inclined to complete the transaction.

Once the customer 310 presents the Transaction Code or Authentication ID to a collection agent 350 of his choice (step 524), the collection agent 350 may validate or verify the amount to be paid by linking or accessing the facilitator's 330 computer network (step 525). The collection agent 350 may link to the facilitator's 330 computer network using any device that allows for validation of the Transaction code or other informational query to the facilitator's 330 computer network. Examples of these devices include, but are not limited to, a computer, personal digital assistants, cellular phones, a kiosk, etc.

An example of how a collection agent 350 may access the facilitator's 330 computer network using the above devices is through the Internet and a web browser. The collection agent 350 may use any computer or web-enabled devices (wired or wireless) to access Web applications or Web services that reside in the facilitator's 330 servers. A Web service, for example, is defined as a programmatic interface to specific processing logic provided by an application running on a server and available via a computer network. Such Web services may allow the collection agent 350 to retrieve the data (step 527) in a particular transaction or retrieve the Transaction Amount and its payment status (e.g., whether paid or not) using the Transaction Code or Authentication ID. FIG. 12 shows an example of how a collection agent 350 may connect and exchange information with the facilitator's 330 computer network through wireless devices using Wireless Access Protocol (WAP) and transmitting data in Wireless Markup Language (WML) format.

After the customer 310 tenders payment of the Transaction Amount, the collection agent may mark the transaction as paid and enter the amount received (Payment Amount) on the field provided in the facilitator's 330 web page (step 529). The transmission of this information to the facilitator 330 from the collection agent 350 then triggers the facilitator's 330 server to log the payment transaction and to generate a Payment File (step 531). Preferably, this Payment File is in XML format, but may also be in any appropriate file format suitable for storing and presenting information. The Payment File may, for example, include the following fields:

<?xml version=“1.0”?>
<!DOCTYPE Payment>
<Payment>
<Transaction AID=“1-8141-6598-4436-2235-8”>

<Order OID=“0793FDE5” />
<Customer CID=“123456ASM” />
<PaymentAmount CurrencyType=“USD”>21.99</PaymentAmount>

<Agent LocationID=“0563FDA5-DE46-31DA-93F3-

55C799B1D0F9”>ABC DINER</Agent>
<ShipGoods>True</ShipGoods>

</Transaction>
</Payment>

The Payment File may be transmitted to the merchant 300 or made available for download to the merchant 300 from the facilitator's 330 server. Multiple payment transactions may also be collected together into a single Payment Batch File that is either transmitted or otherwise made available to the merchants. The Payment Batch File may include, for example:

<?xml version=“1.0”?>
<!DOCTYPE Payment>
<Payment>
<Transaction AID=“1-8141-6598-4436-2235-8”>

<Order OID=“0793FDE5” />
<Customer CID=“123456ASM” />
<PaymentAmount CurrencyType=“USD”>21.99</PaymentAmount>

<Agent LocationID=“0563FDA5-DE46-31DA-93F3-

55C799B1D0F9”>ABC DINER</Agent>
<ShipGoods>True</ShipGoods>

```
  </Transaction>
  <Transaction AID=“9-5698-2658-4659-2335-5”>
```

<Order OID=“179EF4E6” />
<PaymentAmount CurrencyType=“USD”>6.99</PaymentAmount>
<Agent LocationID=“0563FDA5-DE46-31DA-93F3-
55C799B1D0F9”>XYZ Skateland</Agent>
<ShipGoods>False</ShipGoods>

<Transaction>
<Payment>

Once the merchant 300 receives notification that the particular transaction has been paid (step 533), the merchant may 300 then mark the order as paid in its own system (step 534) and supply the goods or services to the customer 310 (step 540).

In addition to generating the Payment Files, the facilitator's server may also generate Automatic Clearing House (ACH) files for the collection agent 350 (debit) and for the merchant 300 (credit) and submit them to the appropriate financial institution (steps 535, 537, and 539). The ACH files may be generated on a daily, weekly, or monthly basis, or any other period of time as agreed to by the facilitator 330, merchants 300, and collection agents 350.

With the above-described transaction, the customer 310 need not provide his or her credit-card information over the Internet. Instead, he or she may visit the desired collection agent 350 and pay by cash or even by credit card. This may be a desirable alternative to using a credit card for online purchases because all privacy concerns are avoided, and the consumer 310 may have greater trust and confidence in the collection agent at which payment is made. This in turn may generally result in increased commerce.

It is preferred, but not necessary, that the computer system of the collection agent 350 be modified to account for the different type of transactions discussed above. In particular, the collection agent's 350 point-of-sale (POS) operating system may be modified to create records of the transactions. The records, recorded in electronic databases, may include the order or transaction information, e.g., transaction code or number, item number, payment amount, or other information that the collection agent 350 may want to be logged into the POS system. For example, in a situation where the collection agent 350 does not offer the product or service ordered but instead merely receives payment on behalf of the merchant 300, the order may be entered as a miscellaneous tender and processed as a credit card sale. This particular transaction may be logged into a first database in the POS system for recording transactions whereby the collection agent 350 merely acted as a payment center.

Alternatively, if the collection agent 350 has the ordered product or service and supplies it to the customer 310, the order may be processed as a cash transaction. The order or transaction information may then be logged into a second database in the POS system for recording transactions whereby the collection agent 350 supplied the product or service and is required to transmit a referral fee. The transaction record may assist the collection agent's 350 sales and accounting procedures or systems, or may also be used to later report the order information to the facilitator 330 or merchant 300 at which the order was generated.

As described above, after the customer 310 orders a product or service from the merchant 300, the merchant 300 or facilitator 330 may fax or mail an invoice, or transmit the invoice in a printable file or XML document to the customer 310 to be printed with the customer's 310 printer, kiosk printer, or other printer. FIG. 9 depicts an example of such an order form or invoice 900 that is printed. In addition to the transaction code and order information, the order form 900 may also include promotional advertising 905 or discounts 910 or some other type of coupon-related marketing effort. These promotional advertisements 905 or discounts 910 may be related, but not limited, to the product or service ordered from the Internet merchant 300 and may be provided by the collection agents 350 who seek to influence the customer's decision on which collection agent 350 to visit.

For example, a local sporting goods store may provide a coupon for purchase of a helmet, which is related to an item that was ordered from the Internet merchant 300. This may motivate the customer 310 to visit this particular sporting goods store rather than a bookstore to make payment. As such, customer traffic may be directed to the sporting goods store instead of the bookstore even though the bookstore may be closer to the customer 310. Accordingly, there are many ways that collection agents 350 may benefit from participating in the network 290 of the current invention.

Alternatively, the promotional advertisement may include a lottery contest advertising 920 or promotional game with a particular product or service as a prize. For example, one out of a certain number of transaction codes may be randomly pre-selected to receive a particular prize. When the customer 310 presents the code to the collection agent 350 for payment and the collection agent 350 transmits the pre-selected code to the facilitator 330, a message that the customer 310 has won a prize is transmitted back to the collection agent 350. The prize will then be sent to the customer 310 directly or to the collection agent 350 for the customer 310 to pick up. This lottery contest may add extra motivation to the customer 310 to actually complete the transaction she had initiated with the merchant 300.

Another embodiment of the invention is now described whereby the online order or the Transaction Code need not be printed on paper. Instead, the order or the Transaction Code may be stored in a memory similar to the secondary memory 215 described above in connection with FIG. 2. The memory may comprise, for example, any portable memory device such as a magnetic or optical disk, flash memory, a personal digital assistant (PDA) such as a Palmpilot or Handspring Visor device, cellular telephone, or any other suitable memory device. The memory may also reside, and the online order may be stored at, the merchant's 300 server, the facilitator's 330 server or electronically forwarded via email or other communication network such as EDI to the collection agent's 350 computer system or server.

Using a suitable memory reader, the online order or the Transaction Code may then be accessed by the collection agent 350 through its POS system or other devices such as a kiosk 800 (FIG. 8) at its location 350. Examples of suitable memory readers include magnetic or optical drive readers, flash memory readers, docking cradles for PDAs or cellular telephones, wireless links with PDAs or cellular telephones such as infrared or radio wave links, or any other suitable communication links or readers. Alternatively, the collection agent 350 may retrieve the order information through computer network connections from the collection agent's 350 own computer server if the order information has been forwarded to the collection agent 350. The collection agent 350 may alternatively retrieve the order information from the merchant 300 or facilitator's 330 server, or even the consumer's 310 server.

Since in this embodiment, the order information or the Transaction Code is preferably not printed out on paper, a second code or a file name that may be easily remembered by the customer 310 is preferably associated with the online order or Transaction Code. The second code or file name may include the customer's 310 name, telephone number, address, or social security number, etc. that may be used to retrieve the order information from the memory. In addition, the merchant 300 may also assign the customer 310 with an identification number such that all of the particular customer's 310 present and future transactions or orders may be associated with that customer 310 for convenience purposes. A password or access code known only to the customer 310 may be required to retrieve and/or unlock the order information, which may have been encrypted or otherwise secured. In the latter situation, requiring a password or access code may help ensure security and authenticate the particular customer 310.

An example of a transaction where the online order may not be printed out is now described with reference to FIG. 6. As shown, a consumer 600 may use a computer 630 as well as some type of portable memory device such as a PDA 640 or storage disk 650 to interface with the network 697. As discussed with the foregoing embodiments, the network 697 preferably includes a plurality of merchants 610 and collection agents 660 that are generally represented as computers in FIG. 6. The consumers 600, merchants 610, and collection agents 660 may generally interface over the Internet 620, a secure network 695, or other network. But it is also contemplated that a single merchant, in addition to functioning as a merchant, may contract with a plurality of collection agents to collect and forward payments to the merchants. In this situation, the merchant may also serve the function of a facilitator and/or monitor. Thus, an independent facilitator may not be necessary.

After a customer 600 places an order with a merchant 610 over the Internet 620, the online order and information associated therewith or the Transaction Code may be stored in the customer's computer 630 and transferred to a portable memory such as a PDA 640, a storage disk 650 (as shown in FIG. 6) or other types of memory devices. For example, transfer of the online order and information associated therewith or the Transaction Code may occur by copying the digital file containing the online order onto a floppy disk, compact disk, flash memory card, or by downloading the online order onto a PDA 640. The customer may then visit the collection agent 660 whose POS system 670 may include or may be connected to a suitable memory reader such as a disk drive 680, a docking station 690, a wireless communication port (e.g. IR port) for the PDA 640 in FIG. 6, or other means. Using the memory reader, the POS system 670 may retrieve the online order or the Transaction Code from the PDA 640 or storage disk 650 and may verify the online order with the merchant 610 or facilitator, preferably through the Internet 620.

After verification, the collection agent 660 may then accept payment in any customary form from the customer 600. In addition to accepting cash or a check, the POS system may also be equipped with an Electronic-Fund-Transfer (“EFT”)/magnetic card reader for use with payment with a credit or debit card. The collection agent 660 may then electronically forward the payment for the online order through a secure network 695 such as the ACH or EDI network or simply transmit a confirmation of payment to the merchant or facilitator.

As an alternative to storing the order information on the consumer's own memory, after ordering from the merchant 610, the customer 600 may select an option to electronically forward the online order and associated information to the collection agent 660 of his or her choice. As another alternative, the order information may be stored on the server of the facilitator or merchant 610. In this situation, the order may be associated with the customer's personal information such as name, address, telephone number, social security number, etc., or associated with a customer identification number or password assigned to the customer by the merchant or facilitator. To this end, all of a given customer's transactions occurring over the network 697 may be associated with a given password for security and convenience purposes. Upon visiting the collection agent 660, the order may be retrieved from the appropriate memory using the customer's personal information, password, or identification number, or some combination thereof. Afterwards, payment may then be accepted and forwarded as described above.

Another example of a transaction is now described with reference to FIG. 7. In this example, products or services from a merchant 710 may be ordered using a PDA 740, a cellular telephone 750 or any other Web-enabled devices having Internet access capability. This is illustrated in FIG. 7 by representations of wireless communication between the PDA 740 (or cellular telephone 750) and a relay antenna 780 connected to the Internet 790.

In this example, transfer of the online order or the Transaction Code from the customer's computer (not shown) to the PDA 740 or cellular telephone 750 may not be necessary. Instead, the online order may be directly placed with the merchant 710 using the PDA 740 or cellular telephone 750. To this end, the order information or the Transaction Code may be stored in the PDA 740, the cellular telephone 750, a server of the merchant 710, collection agent 760 or facilitator. The order information may be retrieved later by the POS system 770 of the collection agent 760 using a docking station 690 (similar to that shown in FIG. 6), a wireless communication port (e.g. IR port) 730 connected to the POS system 770 or any other suitable memory reader or communication link.

The amount of information stored in the PDA 740 or cellular telephone 750 is preferably minimal, the information including only a reference number, a code or a password (e.g., the Transaction Code). The complete order information may be stored in a server of the merchant 710, collection agent 760 or facilitator, and may be accessed by the collection agent 760 using the reference number, code or password. For example, the reference number, code or password may be communicated to the collection agent's POS system 770 from the PDA 740 or cellular telephone 750 through the IR port 730 as shown in FIG. 7. The communication between the POS system 770 and the PDA 740 or cellular telephone 750 may occur even simultaneously as the customer 700 is placing an order with the merchant using the PDA 740 or cellular telephone 750. Once the reference number, code or password is communicated to the POS system 770, the POS system 770 may retrieve the complete order information from the server of the merchant 710. Payment may then be received by the collection agent and forwarded to the merchant 710 as described above.

Another embodiment of the invention is now described with reference to FIG. 8. In this embodiment, a customer may place an order with an online merchant and utilize a self-payment system located at or near a collection agent to pay for the ordered products or services. With the use of a self-payment system, the customer may pay for an online order without the assistance of an employee of the collection agent. Hence, the collection agent does not have to devote employee time or a substantial amount of employee time to accepting payments for online orders from customers.

As shown in FIG. 8, a kiosk 800 or booth, or any other suitable automated user-interfacing station may be located at or near a collection agent 350 (or elsewhere) and may be connected to the collection agent's computer system 860. The collection agent's computer system 860, in turn, may be connected to the Internet 840 such that the kiosk 800 is also connected to the Internet 840. This connection may allow a customer access to online merchants 810 to place an order or to verify order information with the merchant.

The kiosk may comprise a computer (not shown), a display 870, suitable memory readers similar to those described in conjunction with FIGS. 6 and 7, and a self-payment system. The self-payment system may include, for example, a conventional bill and coin acceptor and dispenser for cash payment and a conventional Electronic-Funds-Transfer (“EFT”)/magnetic-strip card reader 820 for use with a credit card or debit card. Unlike providing the credit card information directly online to the merchant 810 over the Internet 840, the EFT/magnetic-strip card reader 820 may be connected directly or capable of dialing up a secure network 830 such as an electronic transaction card authorization network, the EDI network, or the ACH network. Secure networks 830 for use in conjunction with EFT/magnetic-strip card readers 820 may be similar to those used at gas station pumps or ticket vending machines equipped with electronic credit/debit payment options. Since the secure networks 830 are closed network systems, as opposed to open systems such as the Internet 840, the risks that the customer's credit card information may be misappropriated are reduced.

Using the kiosk 800 in FIG. 8, a customer may place an online order for products or services with a merchant 810. The customer may also download stored order information from a memory device such as a PDA, cellular telephone, computer server, storage disks or other suitable memory devices similar to those described in conjunction with FIGS. 6 and 7. With the order information retrieved from the appropriate memory, the kiosk 800 may verify the order with the merchant 810, if necessary, and display the order information to the customer through a display 870 or any other user-interfacing device. The customer may tender payment to the kiosk 800 either by a credit/debit card using the EFT/magnetic-strip card reader 820 or by cash using the bill and coin acceptor and dispenser.

If a credit/debit card was used, the payment amount may be credited to the collection agent's account for forwarding to the merchant or may be credited directly to the merchant's account by the issuer of the credit or debit card. If the customer pays by cash, the collection agent may at a later time physically collect the cash received by the kiosk 800 and forward the payment to the merchant 810. Advantageously, collection agents that have a kiosk 800 with a self-payment system need not devote employee time to accepting payments from customers when the customers can transact the payments by themselves.

[image]

[image]

[image]

[image]

[image]

[image]

[image]

[image]

[image]

Although the present invention has been described above in the context of certain embodiments, one skilled in the art would understand that various modifications may be made to these embodiments and various equivalents may be substituted without departing from the spirit or scope of the invention.

What is claimed is:

1. A method of facilitating transactions by a consumer over a network that includes a merchant, a collection agent and a facilitator, comprising:
the consumer ordering a good or service from the merchant;
the merchant transmitting order information to the facilitator over the network thereby establishing the order with the facilitator; and
the facilitator providing a list of one or more collection agents.

2. The method of claim 1 further comprising:
the consumer choosing a collection agent at which to make payment for the order.

3. The method of claim 2 wherein the consumer orders the good or service from the merchant's web site and the choosing of a collection agent comprises the consumer clicking on a button or icon displayed at the merchant's web site.

4. The method of claim 3, further comprising:
the merchant transmitting information to the facilitator regarding the consumer's choice of collection agent.

5. The method of claim 4, further comprising:
the facilitator transmitting information regarding the consumer's choice of collection agent to the chosen collection agent.
